(19) United States
(12) Patent Application Publication
(10) Pub. No.: US 2023/0104960 A1
(43) Pub. Date: Apr. 6, 2023

(54) Augmented Reality Navigation and Concierge Systems and Methods of Use

(71) Applicant: Augmented Reality Concierge, LLC, Lewisville, TX (US)

(72) Inventor: Aaron Andrews, Lewisville, TX (US)

(21) Appl. No.: 17/958,888

(22) Filed: Oct. 3, 2022

Related U.S. Application Data
(60) Provisional application No. 63/251,421, filed on Oct. 1, 2021.

(51) Int. Cl. G06T 19/00; G06T 19/20; G06V 20/20; A63B 24/00; G06Q 50/10

(52) U.S. Cl. CPC G06T 19/006; G06T 19/003; G06T 19/20; G06V 20/20; A63B 24/0075; G06Q 50/10

(57) ABSTRACT

Augmented reality navigation systems act as a way-finder to assist users in navigating an indoor or outdoor location geographically. Augmented reality concierge systems provide guidance and concierge assistance to users as they perform certain activities in different environments.

### CROSS-REFERENCE TO RELATED APPLICATIONS

This application claims the benefit of U.S. Provisional Patent Application Ser. No. 63/251,421 filed Oct. 1, 2021, and entitled “Augmented Reality Navigation and Concierge Systems and Methods of Use”, which is incorporated herein by referenced in its entirety.

### TECHNICAL FIELD

The present disclosure relates to augmented reality navigation and/or concierge systems and associated methods of use.

### BACKGROUND

In a traditional gym or fitness center environment, a member who wants to workout with a personal trainer is required to go to a specific gym or fitness center to complete the workout at an appointed time rather than having the flexibility to workout with the personal trainer at the location and time that is best suited for the member.

Likewise, in a traditional gym or fitness center environment, a personal trainer can only effectively supervise the workout of one member, or a small number of members, at a time, and the personal trainer is required to be at a specific gym or fitness center at the appointed workout time.

### BRIEF DESCRIPTION OF THE DRAWINGS

For a more complete understanding of this disclosure and its features, reference is now made to the following description, taken in conjunction with the accompanying drawings, in which:

FIGS. 1A through 1L illustrate representative images of onboarding screens for a mobile application of the present disclosure that guides a user through a workout.

FIGS. 2A through 2E illustrate representative images of home screens for a mobile application of the present disclosure that guides a user through a workout.

FIGS. 3A through 3T illustrate representative images of workout screens for a mobile application of the present disclosure that guides a user through a workout at a standard gym.

FIGS. 4A through 4M illustrate representative images of screens for a mobile application of the present disclosure that guides a user to a workout facility equipped to interact with the mobile application to provide augmented reality navigation and/or concierge services while guiding the user through a workout.

FIG. 5A through 5D illustrate representative images of workout screens for a mobile application of the present disclosure that guides a user through a workout at home.

FIGS. 6A through 6D illustrate representative images of workout screens for a mobile application of the present disclosure that guides a user through a workout assigned by the user's trainer.

FIGS. 7A through 7E illustrate representative images of trainer module screens for a mobile application of the present disclosure that allows a trainer to monitor the progress of clients and assign workouts to users of the mobile application.

FIGS. 8A through 8J illustrate representative images of onboarding screens for a mobile application of the present disclosure for use on a university campus.

FIGS. 9A through 9G illustrate representative images of home and navigation screens for a mobile application of the present disclosure used on a university campus equipped to interact with the mobile application to provide augmented reality navigation.

FIGS. 10A through 10D illustrate representative images of home and schedules screens for a mobile application of the present disclosure used on a university campus.

FIGS. 11A through 11E illustrate representative images of home and study groups screens for a mobile application of the present disclosure used on a university campus.

FIGS. 12A through 12C illustrate representative images of home and campus store screens for a mobile application of the present disclosure used on a university campus.

FIGS. 13A through 13E illustrate representative images of home, find a friend, SOS, mental health, and menu screens for a mobile application of the present disclosure used on a university campus.

Like reference symbols in the various drawings indicate like elements.

### DETAILED DESCRIPTION

The present disclosure is directed to augmented reality navigation and/or concierge systems and associated methods of use.

In some implementations, the systems of the present disclosure comprise mobile application software downloaded onto smartphones or other mobile devices of users. The mobile application software may utilize GPS and navigation technologies to enable users to explore indoor or outdoor locations via the camera view on their smartphone. In some implementations, the systems of the present disclosure further comprise software as a service (SAAS) that enables subscribing facilities to provide the augmented reality systems for the benefit of their customers and/or employees.

The systems and methods of the present disclosure may act as a way-finder to assist users in navigating an indoor or outdoor location geographically. The systems and methods of the present disclosure may provide guidance and concierge assistance to users as they perform certain activities, either within or remotely from their own homes.

In some implementations, the systems and methods of the present disclosure provide a detailed, accurate rendering of the interior and/or exterior of a relevant location, including the position of specific items within the location, where applicable (e.g., gym equipment, classroom layout). The systems and methods of the present disclosure may be applied in any number of locations, facilities, industries, and environments, including but not limited to gyms, fitness centers, university campuses, airports, shopping malls, grocery stores, and theme parks.

### System Overview

In some implementations, the systems of the present disclosure comprise an augmented reality concierge (ARC) platform provided to users in the form of a downloadable mobile application built on native iOS and Android technologies. The ARC platform may rely on CMX technology and GPS technologies for indoor and outdoor navigation, respectively. For indoor navigation, the CMX technology captures the location of relevant components, such as the location of equipment within a gym, classrooms within a university building, desks within a classroom, etc.

In some implementations, a user can install the mobile application onto their mobile device from the App Store/Play Store and then register as a user of the system. To use the ARC platform, mobile devices should be augmented reality (AR) compatible, and the CMX technology will be derived from the ARC platform over the Internet.

In some implementations, the ARC platform relies on several different elements, including an underlying powerful dynamic positioning platform provided in the CMX technology, beacons positioned at strategic access points within a facility, such as on gym equipment, for example, and internal sensors of a user's mobile device. Blueprints of the facility are used to capture the positions of the beacons within the CMX technology. The beacons broadcast signals that are received by the internal sensors in the user's mobile device and then served to the CMX positioning system to calculate the indoor position of the device using a complex mathematical algorithm. The incoming data to the internal sensors is combined to calculate a very accurate position of the mobile device, with little to no latency, resulting in a smooth experience for the user.

Maintenance should only be required when there is a change at any access point within the facility. Whenever a change occurs, the particular location/access point is updated and the zone in which the access point is located may be recalibrated. Once such a change is made in the ARC platform, users will see the facility change during their use of the mobile application.

In some implementations, the ARC platform is designed to interface with other technologies to add functionality. For example, the ARC mobile application may employ facial recognition software developed by others, the ARC mobile application may receive user data from fitness wearables, the ARC mobile application may review a contacts list on a user's mobile device to suggest study group members, the ARC mobile application may interact with a calendar feature on a user's mobile device to suggest available times for a workout or a study group meeting, etc.

### Gym or Fitness Center

In a gym or fitness center environment, the systems and methods of the present disclosure may allow users to workout with an augmented reality (AR) personal trainer. Such a system enables users to carry their workout regime anywhere they go, and to access that workout regime anytime they desire (24 hours per day, 7 days per week), rather than being required to go to a specific gym or fitness center at an appointed time to workout with a human personal trainer.

In a gym or fitness center environment, the AR personal trainer may navigate the user through a workout utilizing a detailed, accurate rendering of the interior of the facility, including the location of the gym equipment. However, the workout may or may not require use of the gym equipment.

In some implementations, as the AR personal trainer guides the user through the workout, the AR personal trainer will instruct the user what exercises to do and demonstrate how to do those exercises safely and effectively. The AR personal trainer may demonstrate the exercises using 3D animation and tips. The systems of the present disclosure may also enable users to access “how to” features for information and 3D animation about how to use a specific piece of gym equipment.

In some implementations, the systems may include an “SOS” button that users can activate should they require assistance from a human personal trainer or gym staff while on the gym floor. For example, a mobile application of the present disclosure may include an “SOS” button on a screen. When a user needs assistance at a particular piece of equipment or in a certain area of the gym, the user can press the “SOS” button and an instant message will be sent to the onsite trainers and staff at the gym. When a trainer or staff member responds to the request, the request can be closed out in the system.

In a home environment, the AR personal trainer may similarly navigate the user through an exercise program, with or without home gym equipment.

In some implementations, the systems and methods of the present disclosure may enable customized workouts. For example, users may access workouts uploaded for them by their coaches or personal trainers, users may request workouts focused on specific body parts, users may choose workouts from a range of available workouts, and/or users may virtually participate in group workout classes. The systems and methods of the present disclosure may support other variations of customized workouts.

In some implementations, the systems and methods of the present disclosure may enable tailored diets and nutrition plans. For example, users may access nutrition plans uploaded for them by their dietitians or personal trainers, users may request diets of a specific duration, users may request nutrition plans within a category (protein-based, vegetarian, vegan, gluten free), users may choose diets or nutrition plans from a range of available choices, and/or users may virtually participate in nutrition-oriented classes and/or groups. The systems and methods of the present disclosure may support other variations of tailored diets and nutrition plans.

In some implementations, the systems and methods of the present disclosure may include data management and tracking capabilities. For example, the systems of the present disclosure may manually or automatically record results, log progress, track analytics, generate reports, and/or communicate with fitness wearables to capture user data from those devices. With this information, users, coaches, personal trainers, dietitians, etc. can remotely manage and track user progress, and employers can remotely track data for employee wellness to lower insurance costs and for other purposes. Likewise, gyms and fitness centers can track use of their facilities and equipment. The systems and methods of the present disclosure may also conduct post-workout surveys to gather subjective feedback and rankings from users. The systems and methods of the present disclosure may support other variations of data management and tracking capabilities.

### Representative Gym or Fitness Center Mobile Application Screens

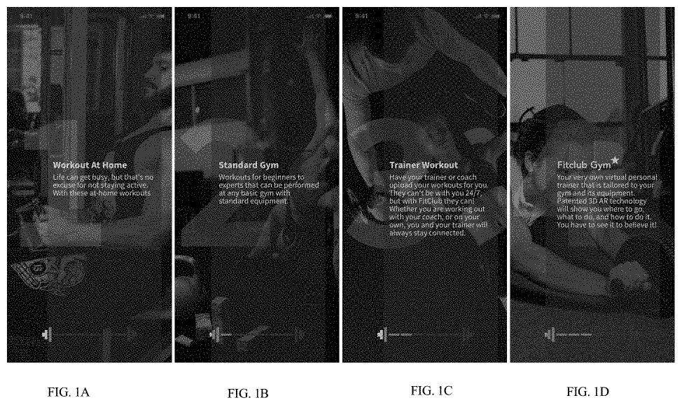

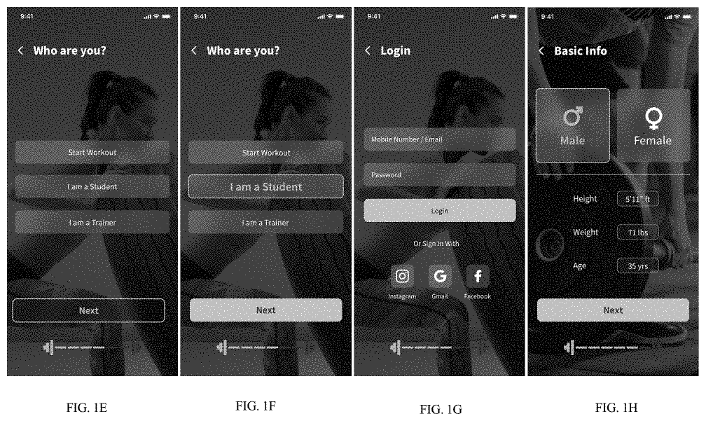

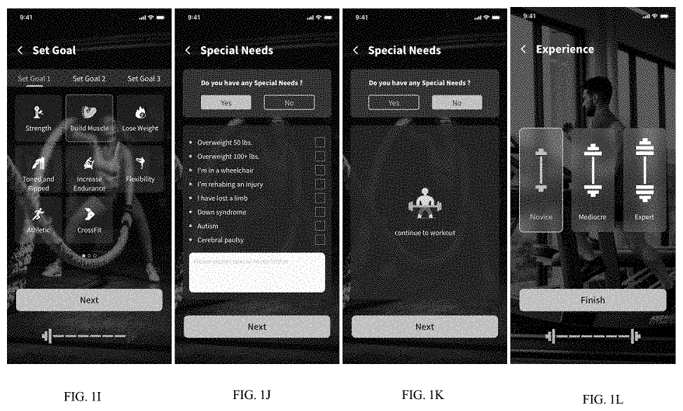

FIGS. 1A through 1L illustrate representative images of onboarding screens for a mobile application of the present disclosure that guides a user through a workout.

In some implementations, the first few onboarding screens explain the various workout options available to the user through the mobile application. For example, FIG. 1A explains a “Workout At Home” option, FIG. 1B explains a “Standard Gym” workout option, FIG. 1C explains a “Trainer Workout” option where the user follows a workout uploaded by a personal trainer, and FIG. 1D explains a “Fitclub Gym” option where the user is guided through a workout by a virtual personal trainer.

In some implementations, the next set of screens gather information about the user and their goals. For example, FIG. 1E displays “Who are you?” at the top and presents several user selection options: “Start Workout”, “I am a Student” or “I am a Trainer”. FIG. 1F shows how the FIG. 1E screen looks if a user selects “I am a Student”, which lights up the “Next” button at the bottom of the screen. Once the “Next” button is pushed, the user may be taken to the “Login” screen shown in FIG. 1G, which prompts the user to enter a mobile number or email address and a Password before clicking the “Login” button. The user may also be able to sign in through other platforms, such as Instagram, Gmail or Facebook. Once the user has logged in, the “Basic Info” screen of FIG. 1H may be presented. On this screen, the user may click a button to indicate “Male” or “Female” and may type in other relevant information, such as height, weight and age before clicking the “Next” button.

Once the “Next” button on the screen of FIG. 1H is pushed, the user may be taken to the “Set Goal” screen shown in FIG. 1I. Here, the mobile application may allow the user to indicate one or more goals by clicking on the available icons, such as: “Strength”, “Build Muscle”, “Lose Weight”, “Toned and Ripped”, “Increase Endurance”, “Flexibility”, “Athletic” and “CrossFit” before clicking the “Next” button. Once the “Next” button on the screen of FIG. 1I is pushed, the user may be taken to the “Special Needs” screen shown in FIG. 1J. On this screen, the user may click a button to indicate “Yes” or “No” to the question: “Do you have any Special Needs?” and may then click a box next to any special needs the user may have, such as: “Overweight 50 lbs.”, “Overweigh 100+lbs.”, “I'm in a wheelchair”, “I'm rehabbing an injury”, “I have a lost limb”, “Down syndrome”, “Autism”, and “Cerebral palsy”. A box may also be provided for the user to type in an explanation of their special needs. FIG. 1K shows how the FIG. 1J screen looks if a user selects “No” to the question about special needs, which presents a “continue to workout” icon that the user may select, and also lights up the “Next” button at the bottom of the screen. Once the “Next” button is pushed on the screen of FIG. 1K, the user may be taken to the “Experience” screen of the mobile app shown in FIG. 1L. On this screen, the user may click a button to indicate that the user's experience level, such as: “Novice”, “Mediocre”, and “Expert”. Once an experience level button is selected, the “Finish” button at the bottom of the screen lights up, and the user may press that button to complete the onboarding process.

Referring again to the screen shots of FIGS. 1A through 1L, as the user moves through these screens, an indicator at the bottom of the screen shows how far along the user has progressed in the onboarding process. In some implementations, the indictor is a segmented barbell with weights, as shown in FIGS. 1A through 1L.

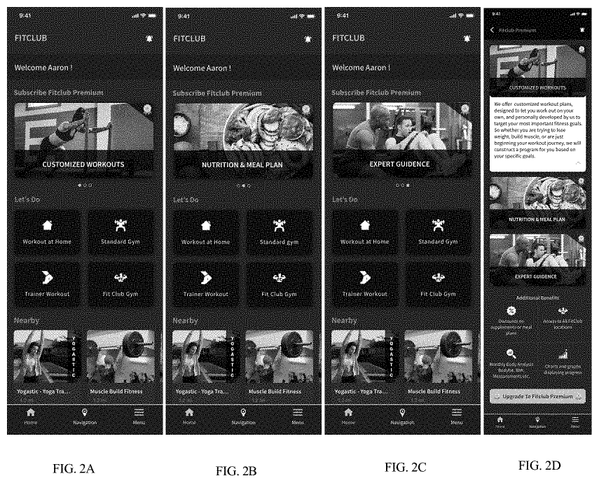

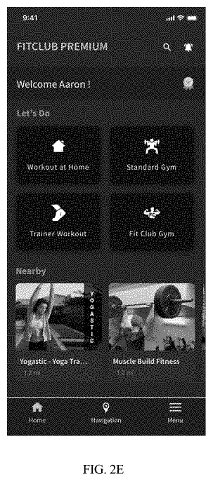

FIGS. 2A through 2E illustrate representative images of home screens for a mobile application of the present disclosure that guides a user through a workout. Note “Home” icon is lit at the bottom of each screen, indicating that FIGS. 2A through 2E depict home screens. In some implementations, FIGS. 2A through 2D illustrate representative home screens for a user with a regular membership, referred to as “FITCLUB”, and FIG. 2E illustrates a representative home screen for a user with a premium membership, referred to as “FITCLUB PREMIUM”.

Referring again to FIGS. 2A through 2C, the home screen of the regular membership may include a scrolling advertising banner at the top that encourages the user to “Subscribe Fitclub Premium”, which will allow the user to access “CUSTOMIZED WORKOUTS” as shown on FIG. 2A, “NUTRITION & MEAL PLAN” as shown on FIG. 2B, and “EXPERT GUIDANCE” as shown on FIG. 2C.

A gold award ribbon icon is depicted in the upper right corner of each of these scrolling advertisements in FIGS. 2A through 2C. As shown in FIG. 2D, if the gold award ribbon icon in the “CUSTOMIZED WORKOUTS” advertisement is selected, a drop down box describing that specific feature of the premium membership is displayed on the screen. Although not depicted, similar drop down boxes may appear if the gold award ribbon icons for the other two advertisements are selected. Below the advertisements, FIG. 2D also displays a list of “Additional Benefits” of a premium membership, which may include: “Discounts on supplements or meal plans”, “Access to All FitClub locations”, “Monthly Body Analysis, Bodyfat, BMI, Measurements, etc.” and “Charts and Graphs displaying progress”. FIG. 2D also depicts a lighted button toward the bottom of the screen for “Upgrade to Fitclub Premium.” If that button is pressed, the user will be redirected to one or more other screens to complete the membership upgrade process.

As shown in FIGS. 2A through 2E, regardless of whether the user has a regular “FITCLUB” membership or a premium “FITCLUB PREMIUM” membership, there are “Let's Do” buttons provided in the middle of the home screen for the user to select a workout type, which may include: “Workout at Home”, “Standard Gym”, “Trainer Workout” or “Fit Club Gym”. In a “Nearby” section toward the bottom of the home screens, there are also images for nearby workout facilities and the distance to those workout facilities based on the location of the user's mobile device, which may be determined by GPS technology.

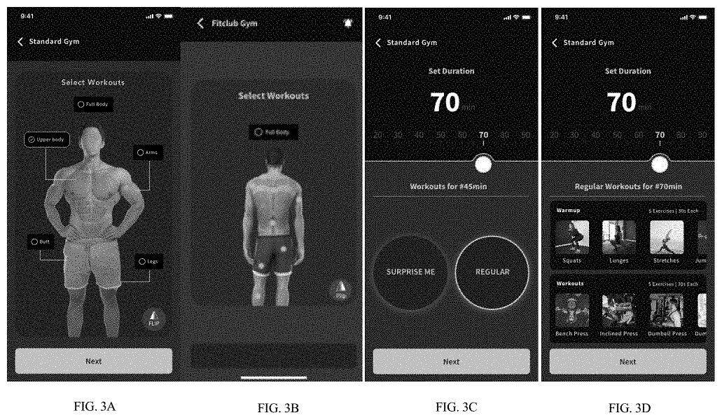

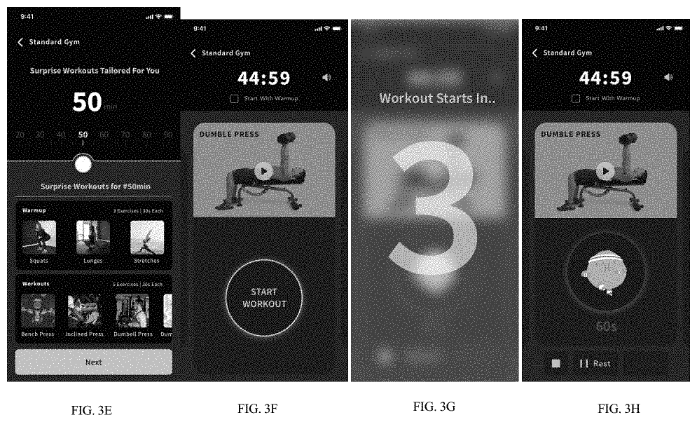

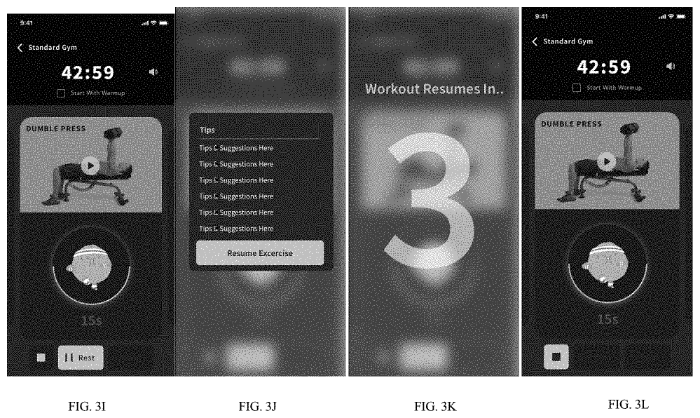

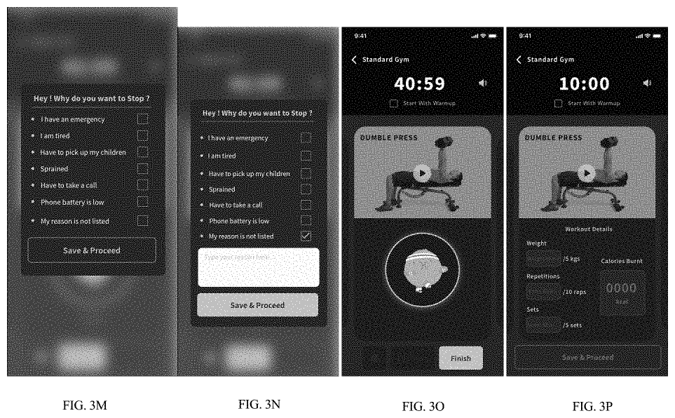

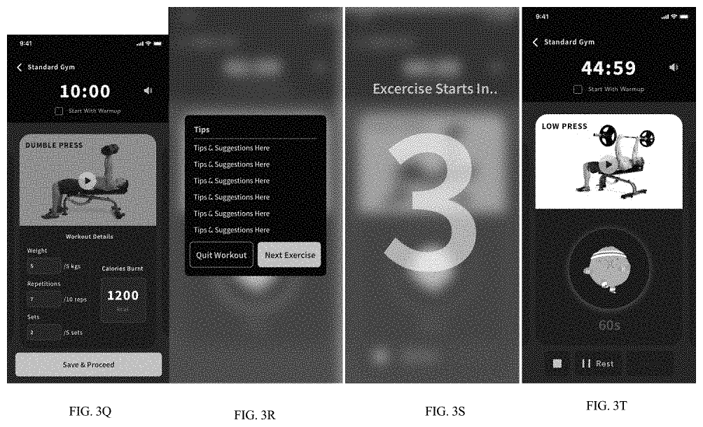

If a user selects “Standard Gym” from the “Let's Do” menu on the home screens of FIGS. 2A through 2E, then FIGS. 3A through 3T illustrate representative images of various workout screens for a mobile application of the present disclosure that guides a user through a workout at a standard gym.

The screen shown in FIG. 3A depicts a representation of the front of a human body, which in some implementations may indicate areas of the body with annotated labels such as “Full Body”, “Upper Body”, “Arms”, “Legs” and “Butt”. The screen shown FIG. 3B depicts a representation of the back of a human body, which in some implementations may indicate areas of the body with highlighted dots. On both screens a “Flip” button is provided that enables a user to move between the screen shown in FIG. 3A and the screen shown in FIG. 3B. While on either the screen of FIG. 3A or the screen of FIG. 3B, the user may select the area of the body for a workout and then presses the “Next” button at the bottom. Once the user selects the area of the body, FIG. 3C depicts a screen that allows the user to “Set Duration” of the workout using a variable timer and to select between “Surprise Me” or “Regular” workouts before pressing the “Next” button at the bottom. FIG. 3D depicts a representation of the screen that comes up if the user sets a 70-minute duration and selects “Regular” on the FIG. 3C screen. Images for “Warmup” and “Workouts” are depicted for a user to select and then press the “Next” button at the bottom. Similarly, FIG. 3E depicts a representation of the screen that comes up if the user sets a 50-minute duration and selects “Surprise Me” on the FIG. 3C screen. Images for “Warmup” and “Workouts” are depicted for a user to select and then press the “Next” button at the bottom.

FIGS. 3F through 3R depict a representative series of screens of the mobile application of the present disclosure when guiding a user through a first exercise in a workout. FIG. 3F depicts a timer at the top, a video that a user may play to show the user how to properly perform the exercise, and a “START WORKOUT” button at the bottom. Once a user presses the “START WORKOUT” button, FIG. 3G shows a countdown screen letting the user know when the workout will start. FIG. 3H depicts a timer at the top, the same video provided on the FIG. 3F screen, a character along with a timer for that exercise (60 seconds) below the video, and buttons at the bottom to allow a user to stop the exercise or “Rest”. FIG. 3I depicts the screen of FIG. 3H after 45 seconds of the 60 second timer has elapsed and the user has pressed the “Rest” button. FIG. 3J depicts a screen providing “Tips & Suggestions” to the user while resting, and a “Resume Exercise” button at the bottom. Once a user presses the “Resume Exercise” button on the FIG. 3J screen, FIG. 3K shows a countdown screen letting the user know when the workout will resume. FIG. 3L depicts the screen of 3I, which includes a “Stop” button at the bottom. FIG. 3M depicts a screen that the mobile application may display if the user presses the “Stop” button, asking: “Hey! Why do you want to Stop?” and providing a list of options for the user to check, such as: “I have an emergency”, “I am tired”, “Have to pick up my children”, “Sprained”, “Have to take a call”, “Phone battery is low”, “My reason is not listed”. A “Save & Proceed” button is also provided on this screen to save the user's selection. FIG. 3N depicts a screen that presents a box for the user to type in their reason if they check the box “My reason is not listed” on the FIG. 3M screen. Once the “Save & Proceed” button is pressed, the user is taken to the screen shown in FIG. 3O where the user can click the “Finish” button at the bottom to finish the exercise. FIG. 3P depicts a screen to capture the workout details for that exercise, such as “Weight”, “Repetitions” and “Sets” for a weightlifting exercise. FIG. 3Q depicts the FIG. 3P screen after the user enters the data, and the mobile application calculates the “Calories Burned”, which are displayed on the FIG. 3Q screen. A “Save & Proceed” button is provided at the bottom of the FIG. 3Q screen, and once that button is pressed, the user may be presented the screen shown in FIG. 3R, which again provides “Tips & Suggestions” and allows a user to choose between “Quit Workout” or “Next Exercise”.

If a user selects “Next Exercise” on the FIG. 3R screen, then the mobile application may repeat the process for the next exercise. FIG. 3S shows a countdown screen letting the user know when the next exercise will start. FIG. 3T depicts a timer at the top, a new video that the user may play to show how to properly perform the new exercise, a character along with a timer for that exercise (60 seconds) below the video, and buttons at the bottom to allow a user to stop the exercise or “Rest”. In some implementations, the timer for the exercise (60 seconds) as shown in FIGS. 3H, 3I, 3L, 3O, and 3T may be replaced with another measure, such as a number of repetitions for the exercise, or a number of sets for the exercise, with a number of repetitions in each set.

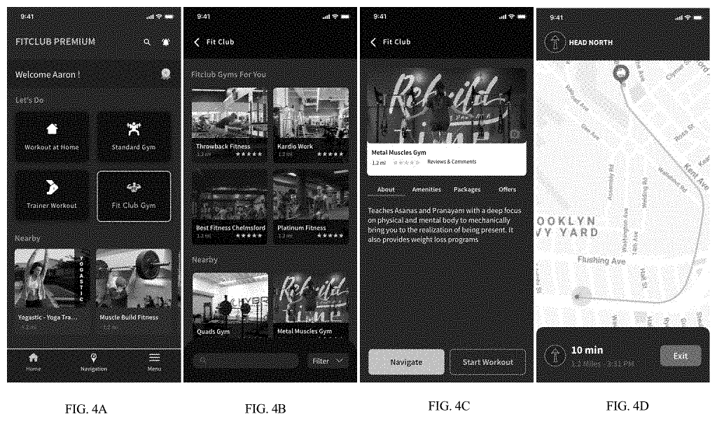

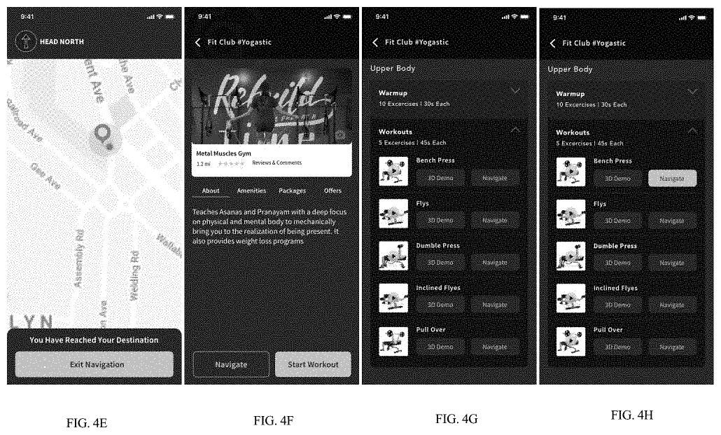

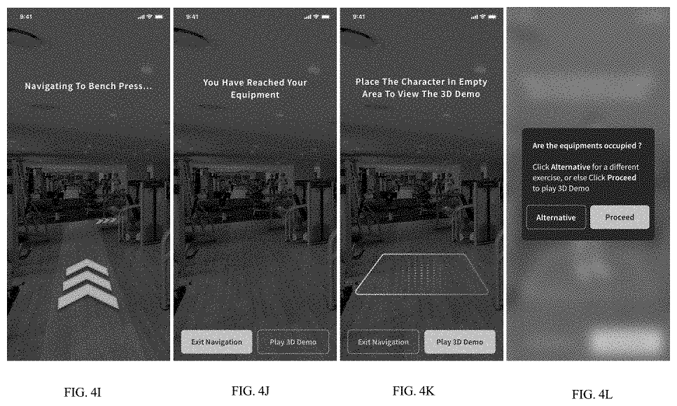

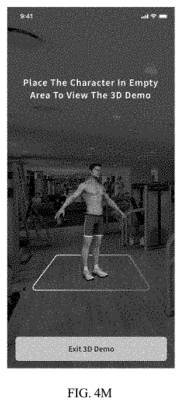

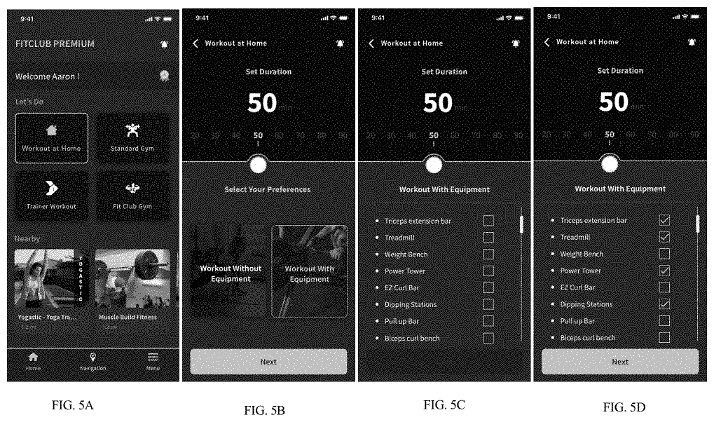

Referring back to the home screens shown in FIGS. 2A through 2E, if a user selects “Fit Club Gym” from the “Let's Do” menu then FIGS. 4A through 4O illustrate representative images of screens for a mobile application of the present disclosure that guides a user to a workout facility equipped to interact with the mobile application to provide augmented reality navigation and/or concierge services while guiding the user through a workout. FIG. 4A shows a home screen with the “Fit Club Gym” button selected, and the screen of FIG. 4B displays images for “Fitclub Gyms For You” and “Nearby”, providing the names of the facilities and the distance to the user's mobile device, which may be determined based on GPS technology. Once a user makes a gym selection, FIG. 4C displays a screen summarizing the gym name, distance, star rating, reviews and comments, and a description of the gym. “Navigate” and “Start Workout” buttons are provided at the bottom of the screen. If a user selects “Navigate” on the FIG. 4C screen, the mobile application of the present disclosure will bring up navigational map screens, such as those shown in FIGS. 4D and 4E, to provide navigational guidance for the user to reach the desired location. The map screen of FIG. 4E includes an “Exit Navigation” button that may be pressed by the user when the desired destination is reached.

FIGS. 4F through 4M illustrate representative images of screens for a mobile application of the present disclosure that guides a user through a workout in a gym or other fitness facility equipped to interact with the mobile application to provide augmented reality navigation and/or concierge services. When the user arrives at the facility with a mobile device, the CMX technology within the facility interacts with the mobile application installed on the mobile device. FIG. 4F shows a representative home screen for the facility that includes “Navigate” and “Start Workout” buttons at the bottom. If the user presses the “Start Workout” button, the screen shown in FIG. 4G may be displayed, allowing the user to select either a “Warmup” or to select from among multiple exercises in a “Workouts” section of the screen. Notably, for each exercise in the “Workouts” section, the user may elect to view a “3D Demo” of the exercise or may elect to “Navigate” to the gym equipment necessary to perform the exercise.

FIG. 4H depicts the screen of FIG. 4G after the “Navigate” button has been selected for the “Bench Press” exercise. Using the camera feature of the mobile device, the mobile application presents navigational screens to direct the user along a path marked with arrows as shown in FIG. 4I and to report “You Have Reached Your Equipment” when appropriate as shown in FIG. 4J. The screen in FIG. 4J also includes “Exit Navigation” and “Play 3D Demo” buttons at the bottom. If the user selects “Exit Navigation”, the screen shown in FIG. 4K is presented that will allow a user to play a 3D Demo. This screen includes the instructions “Place the Character in Empty Area to View the 3D Demo”. Before playing the 3D Demo, the screen of FIG. 4L asks the user whether the equipment is occupied and allows the user to select between “Alternative” to go to a different exercise or “Proceed” to play the 3D Demo. If the user selects “Proceed” at this stage, then the screen shown in FIG. 4M is presented, and the user places an AR personal trainer character in an empty area on the screen to view the 3D Demo. When the 3D Demo has been viewed, the user may press an “Exit 3D Demo” button on the FIG. 4M screen.

Referring back to the home screens shown in FIGS. 2A through 2E, if a user selects “Workout at Home” from the “Let's Do” menu, FIG. 5A through 5D illustrate representative images of workout screens for a mobile application of the present disclosure that guides a user through a workout at home. FIG. 5A shows a home screen with the “Workout at Home” button selected, and the screen of FIG. 5B allows a user to set the duration of the workout and to choose between preferences “Workout Without Equipment” or “Workout With Equipment” before pressing the “Next” button at the bottom. If the user selects “Workout With Equipment”, then the screen of FIG. 5C shows the selected workout duration and provides a list of equipment to select from, such as “Triceps extension bar”, “Treadmill”, “Weight Bench”, “Power Tower”, “EZ Curl Bar”, “Dipping Stations”, “Pull up Bar”, and “Biceps Curl Bench”. FIG. 5D depicts the screen of FIG. 5C with multiple equipment boxes selected before the “Next” button is pressed at the bottom of the screen. The mobile application of the present disclosure may then guide the user through a workout at home in the same manner as the mobile application guides the user through a workout at a “Standard Gym” or at a “Fit Club Gym” as previously described.

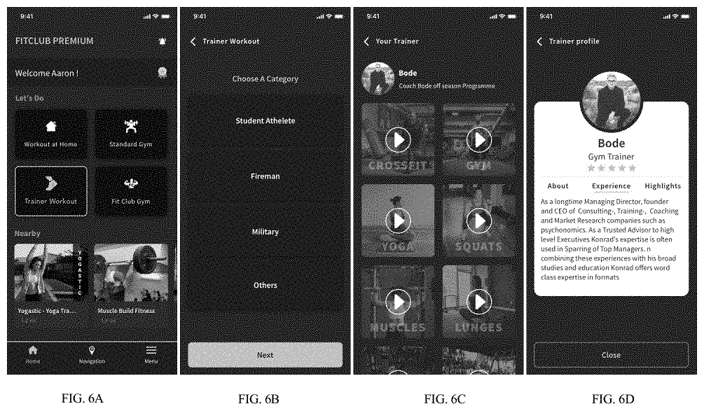

Referring back to the home screens shown in FIGS. 2A through 2E, if a user selects “Trainer Workout” from the “Let's Do” menu, FIGS. 6A through 6D illustrate representative images of workout screens for a mobile application of the present disclosure that guides a user through a workout assigned by the user's trainer. FIG. 6A shows a home screen with the “Trainer Workout” button selected, and the screen of FIG. 6B allows a user to “Choose a Category” that they fall into, such as: “Student Athlete”, “Fireman”, “Military”, and “Others” before pressing the “Next” button at the bottom. FIG. 6C shows a representative screen for the user's personal trainer, and videos of various workout programs that trainer has uploaded, such as: “Crossfit”, “Gym”, “Yoga”, “Squats”, “Muscles”, “Lunges”, etc. From the FIG. 6C screen, the user can select any of the trainer's workout programs and complete the workout while being guided by the video presentation. In other implementations, the mobile application of the present disclosure may guide the user through a trainer workout in the same manner as the mobile application guides the user through a workout at a “Standard Gym” or at a “Fit Club Gym, as previously described. FIG. 6D illustrates a representative informational screen about the user's trainer, including a star rating, “About”, “Experience” and “Highlights”.

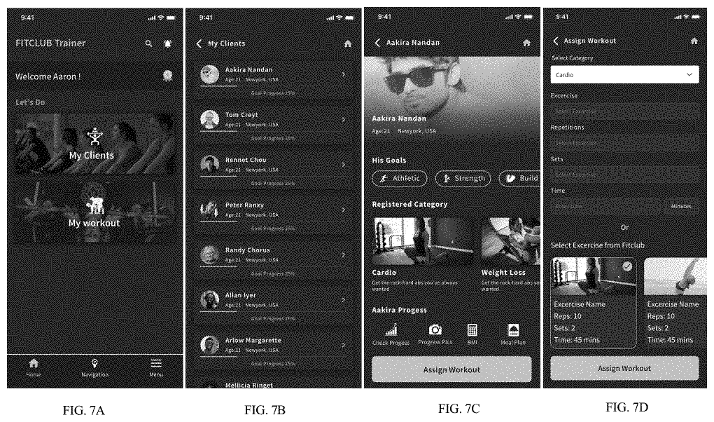

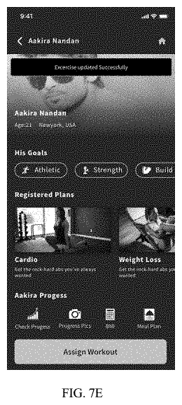

In another implementation, the mobile application of the present disclosure includes different features for users that are personal trainers. In some implementations, the portion of the mobile application used by trainers may be referred to as TrainAR. FIGS. 7A through 7E illustrate representative images of trainer module screens for a mobile application of the present disclosure that allows a trainer to monitor the progress of clients and assign workouts to users of the mobile application. FIG. 7A represents a home page screen that allows the personal trainer to select between “My Clients” and “My workout”. If the trainer selects “My Clients”, FIG. 7B illustrates a representative screen providing a list of the trainer's clients along with a photo, name, age, geographic location, and % Goal Progress for each client. From the screen of FIG. 7B, the trainer can select a particular client, and FIG. 7C illustrates a representative screen summarizing the client, including the client's goals, registered categories such as “Cardio” and “Weight Loss” and showing the client's progress. From the screen of FIG. 7C, the trainer can press the “Assign Workout” button at the bottom, which will bring up the FIG. 7D screen allowing the trainer to assign workout parameters, such as “Category”, “Exercise”, “Repetitions”, “Sets”, and “Time” or the trainer can select an exercise from a fitness facility presented in video format. In one implementation, when the trainer clicks into the “Exercise” box shown on the screen of FIG. 7D, the mobile application presents a drop-down menu of exercises that have been saved into a database. If the trainer is looking for an exercise that has not been saved into the database, the trainer can add that exercise to the database by uploading a new photograph or video, and the exercise will become available in the drop-down menu. Once the workout parameters are entered, the trainer can press the “Assign Workout” button at the bottom of the FIG. 7D screen. FIG. 7E is the screen that confirms the workout has been successfully uploaded for the client.

In some implementations of the TrainAR system, the more workouts that trainers upload into the system, the smarter the system gets because the database grows larger, which gives trainers more workouts to assign and users more workouts to select. In some implementations, when a user completes a workout, the TrainAR system of the present disclosure captures user satisfaction feedback about the workout and/or the gym experience via a post workout survey. The TrainAR system may then rate the workout and/or the gym based on user feedback. In some implementations of the TrainAR system, data is captured that provides analytics to trainers, as well as gym or fitness facility staff and management. These analytics may enable trainers to determine which clients are progressing well in terms of meeting their goals and which ones may need additional help because they are plateauing or not seeing results. Similarly, these analytics may enable gym or fitness facility staff and management to determine which trainers are progressing well and which ones may need additional help.

### University Campus

In a university campus environment, the systems and methods of the present disclosure may navigate users around campus to locate venues, classes, events and parking, explore indoor and outdoor locations, track schedules, shop, find friends on campus, maintain physical and mental health, and otherwise make campus life easier.

In a university campus environment, the systems and methods of the present disclosure may allow users to interact with an AR mascot tour guide. The AR mascot tour guide may navigate the user around campus utilizing a detailed, accurate rendering of the campus. This accurate rendering of the campus may include, but is not limited to, the location of university buildings, and specific layouts of classrooms within university buildings; the location of parking facilities, and the specific layouts and availability of parking spaces within parking facilities; the location of sports venues, and specific layouts of seating and concessions within sports venues; the location of food service facilities, and the specific layouts of food service counters and seating within food service facilities; and other details of the campus.

In some implementations, the AR mascot tour guide navigates the user from building to building and between locations across campus. For example, the AR mascot tour guide may navigate the user to a specific classroom within a university building, and then around the classroom once inside. In some implementations, the systems may include an “SOS” button that users can activate should they require immediate assistance from campus security at any time.

In a university campus environment, the systems and methods of the present disclosure may allow users to interact with an AR mental health guide. Such a system enables users to access mental health guidance anytime they need it (24 hours per day, 7 days per week), rather than being required to go to a specific location at an appointed time to meet with a human mental health professional.

In a university campus environment, the systems and methods of the present disclosure may allow users to workout with an augmented reality (AR) personal trainer, either at the campus gym, or at home. Such a system enables users to carry their workout regime anywhere they go, and to access that workout regime anytime they desire (24 hours per day, 7 days per week).

In some implementations, the systems and methods of the present disclosure may include tracking and planning capabilities. For example, users may track class and activity schedules, users may access campus calendars for upcoming events, users may find or create study groups, users may find friends anywhere on campus, users may monitor capacity at certain locations (such as the student union, cafeteria, library, gym), and/or users may determine real-time parking availability and obtain assistance from their AR mascot tour guide to navigate to an available parking space anywhere on campus. In addition, universities may use the systems and methods of the present disclosure in contact tracing efforts for infectious diseases. The systems and methods of the present disclosure may support other variations of tracking and planning capabilities.

In some implementations, the systems and methods of the present disclosure may enable purchasing. For example, users may purchase items from the campus store, users may purchase tickets to games, users may purchase tickets to campus events, and/or users may purchase food from the campus cafeteria. The systems and methods of the present disclosure may support other types of purchases.

### Representative University Campus Mobile Application Screens

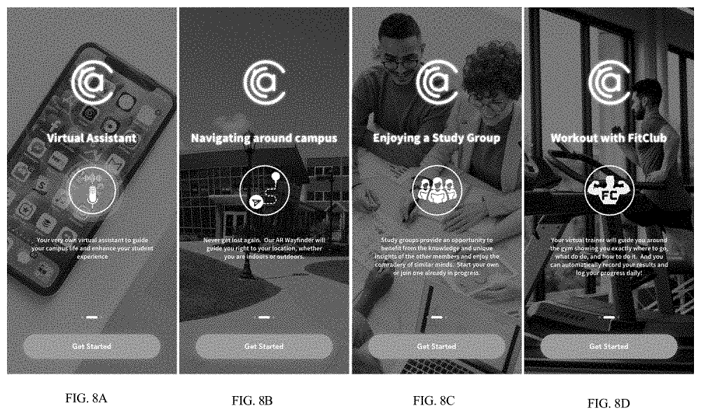

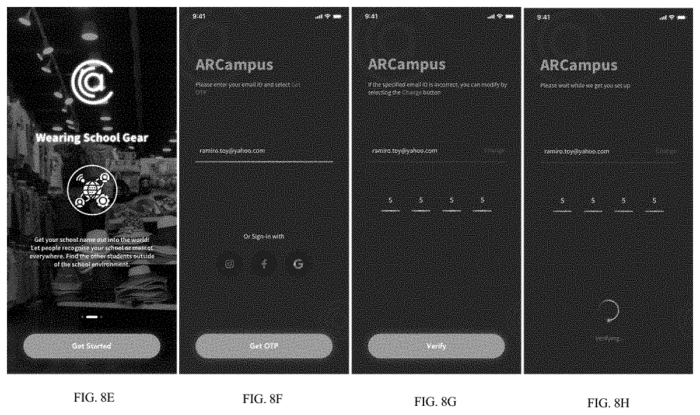

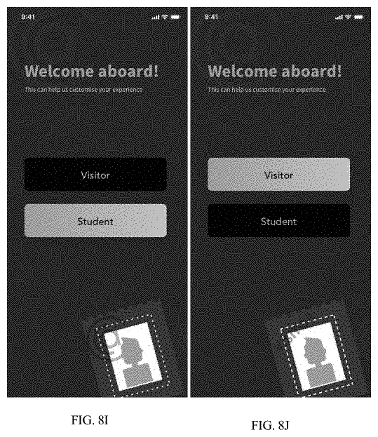

FIGS. 8A through 8J illustrate representative images of onboarding screens for a mobile application of the present disclosure for use on a university campus. In some implementations, the mobile application for use on a university campus may be referred to as ARCampus.

In some implementations, the first few onboarding screens introduce at least some of the various services available to the user through the mobile application. For example, FIG. 8A introduces a “Virtual Assistant” service, FIG. 8B introduces a “Navigating around campus” service, FIG. 8C introduces an “Enjoying a Study Group” service, FIG. 8D introduces a “Workout with FitClub” service, and FIG. 8E introduces a “Wearing School Gear” service. In some implementations, the mobile application automatically scrolls through these introductory onboarding screens, each of which may be equipped with a “Get Started” button at the bottom of the screen.

In some implementations, once the user presses the “Get Started” button on any of the screens shown in FIGS. 8A through 8E, the next set of screens allows the user to sign in to access the services offered through the ARCampus mobile application. For example, the screen shown in FIG. 8F prompts the user to enter an email address and press the “Get OTP” button at the bottom of the screen. The user may also be able to sign in through other platforms, such as Instagram, Facebook or Gmail. Once the user presses the “Get OTP” button, the user may be taken to the screen shown in FIG. 8G where the user is prompted to either change their email address (if it was entered incorrectly), or to enter a 4-digit security code (received via email) before pressing a “Verify” button at the bottom of the screen. FIG. 8H shows the screen that may be displayed once a user selects the “Verify” button. When the user has successfully signed in, the “Welcome aboard” screen of FIG. 8I may be presented. On this screen, the user may click a button to indicate “Student” as shown in FIG. 81 or “Visitor” as shown in FIG. 8J, which allows the mobile application to customize the user experience.

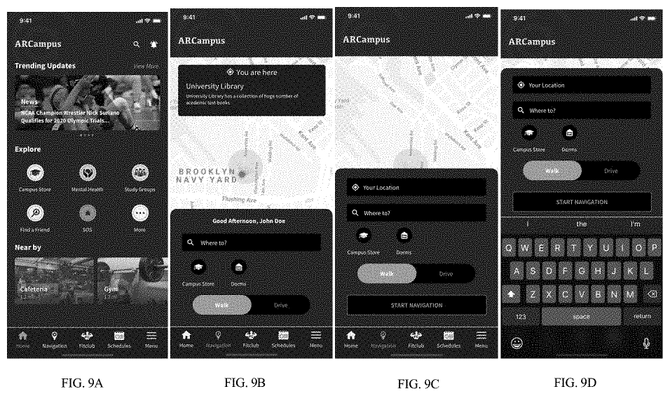

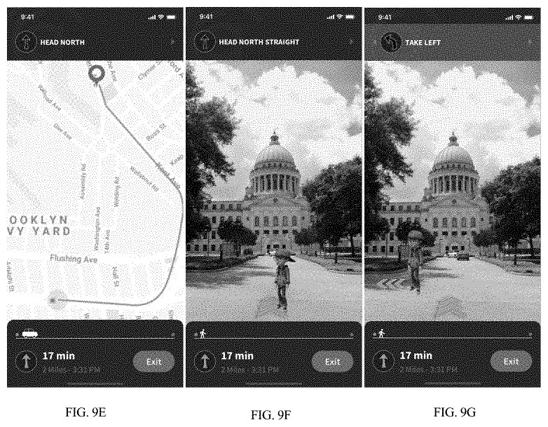

FIG. 9A illustrates a representative home screen, and FIGS. 9B through 9G illustrate representative navigation screens for a mobile application of the present disclosure used on a university campus equipped to interact with the mobile application to provide augmented reality navigation.

Referring to FIG. 9A, the “Home” icon is lit at the bottom of the screen, indicating that this is the home screen of the ARCampus mobile application. The home screen may include a scrolling “Trending Updates” banner at the top that presents the latest university campus news or other information. A “View More” button may be provided adjacent to the “Trending Updates” section, which would allow a user to view additional news items or other information by pressing the “View More” button.

In the middle of the home screen shown in FIG. 9A, a list of services to “Explore” may be presented, including: “Campus Store”, “Mental Health”, “Study Groups”, “Find a Friend”, “SOS” and “More”. In a “Nearby” section toward the bottom of the home screen, there are also images for nearby facilities and the distance to those facilities based on the location of the user's mobile device, which may be determined by GPS technology. At the very bottom of the home screen shown in FIG. 9A, additional functionalities may be provided, including: “Navigation”, “Fitclub”, “Schedules”, and “Menu”.

If a user selects “Navigation” on the home screen of FIG. 9A, the mobile application of the present disclosure may bring up navigational screens, such as those shown in FIG. 9B through 9E, to provide navigational guidance for the user to reach the desired location. Referring to FIG. 9B, the first navigational screen may indicate “You are here” on a map and display the corresponding campus location, such as “University Library” along with a description of that location. The navigational screen of FIG. 9B may also present a “Where to?” text box and several icons for other campus locations that the user may select as destinations, such as “Campus Store” and “Dorms”. The navigational screen of FIG. 9B further includes buttons that allow the user to select “Walk” or “Drive” for the navigational directions.

If a user clicks on the area for selecting a destination, the screen of FIG. 9C is displayed, and if a user clicks in the “Where to?” text box, the screen of FIG. 9D is displayed providing a keyboard for the user to type a destination before pressing the “Start Navigation” button in the middle of the screen shown in FIG. 9D.

FIGS. 9E through 9G illustrate representative images of screens for a mobile application of the present disclosure that guides a user to a destination on a university campus equipped to interact with the mobile application to provide augmented reality navigation and/or concierge services. When a user presses the “Start Navigation” button on the screen of FIG. 9D, the mobile application may display the map screen shown in FIG. 9E that visually displays the route between the user's current location and the destination on a map, provides directional instructions such as “Head North”, provides a travel duration such as “17 min”, and provides a travel distance such as “2 Miles”. The map screen may also include an “Exit” button that enables the user to exit the navigation mode.

In addition, or in the alternative, using the camera feature of the mobile device, the mobile application may present navigational screens that show an AR mascot tour guide that directs the user along a path marked with arrows, as shown in FIGS. 9F and 9G. In more detail, the screens shown in FIGS. 9F and 9G display an AR mascot tour guide leading the user along a university campus walkway marked with green arrows and showing a university campus building in the background. Directional instructions such as “Head North Straight” and “Take Left” are displayed at the top of the screens, which may also provide a travel duration such as “17 min” and a travel distance such as “2 Miles” at the bottom of the screens. The screens of FIGS. 9F and 9G may also include an “Exit” button that enables the user to exit the navigation mode.

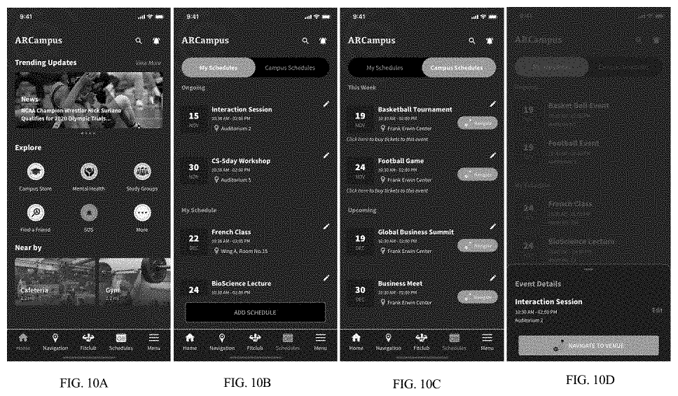

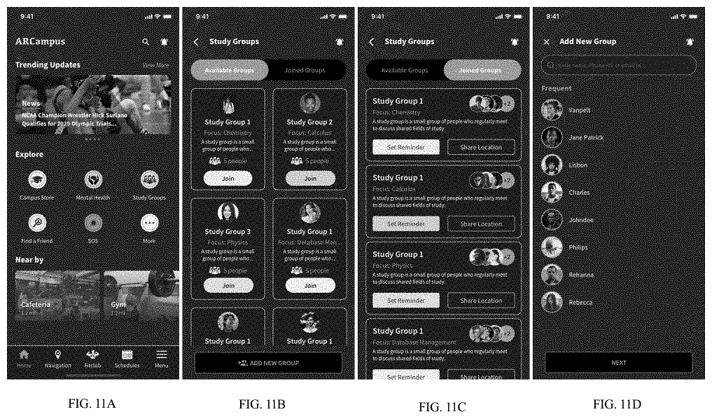

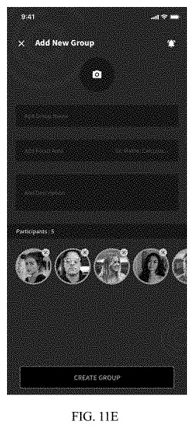

FIG. 10A illustrates a representative home screen, and FIGS. 10B through 10D illustrate representative schedules screens for a mobile application of the present disclosure used on a university campus.

Referring to FIG. 10A, the “Home” icon is lit at the bottom of the screen, indicating that this is a home screen of the ARCampus mobile application. In an implementation, the home screen of FIG. 10A is substantially identical to the home screen of FIG. 9A. If a user selects “Schedules” at the bottom of the home screen of FIG. 10A, the mobile application of the present disclosure may bring up schedule screens, such as those shown in FIG. 10B through 10D, to enable the user to view various personal and campus schedules. Referring to FIGS. 10B and 10C, the user may select either “My Schedules” or “Campus Schedules” via a button at the top of the schedule screen. FIG. 10B depicts a representative screen that may be presented if a user selects “My Schedules”. On this screen, an “Ongoing” section displays various sessions, workshops, and other events that the user has signed up to attend, and an “My Schedule” section displays the user's class, lecture and other events on the user's schedule for that day. The event date, name, time, and location may be shown, and a pencil icon may be presented in the upper right hand corner of each event for the user to select to edit/change/delete the scheduled event. In addition, an “Add Schedule” button may be provided at the bottom of the screen to allow the user to add another type of schedule, such as a workout schedule, an extracurricular activity schedule, a family schedule, or another category of schedule.

FIG. 10C depicts a representative screen that may be presented if a user selects “Campus Schedules”. On this screen, “This Week” and “Upcoming” sections display various sporting events and other campus events that are available this week or in the future. The event date, name, time, and location may be shown, and a pencil icon may be presented in the upper right hand corner of each event for the user to select to edit/change/delete the scheduled event. In addition, the user may be prompted to “Click here to buy tickets to this event” if a campus event requires tickets. Further, a “Navigate” button may be provided next to each event as shown on FIG. 10C, or if a user selects an event, the mobile application may bring up an “Event Details” screen as shown in FIG. 10D that includes a “Navigate to Venue” button at the bottom of the screen. If a user clicks on any of the “Navigate” buttons shown on the screen of FIG. 10C, or the “Navigate to Venue” button shown on the screen of FIG. 10D, the mobile application will bring the user to the navigation service screens, such as the screens described above in connection with FIGS. 9B through 9G.

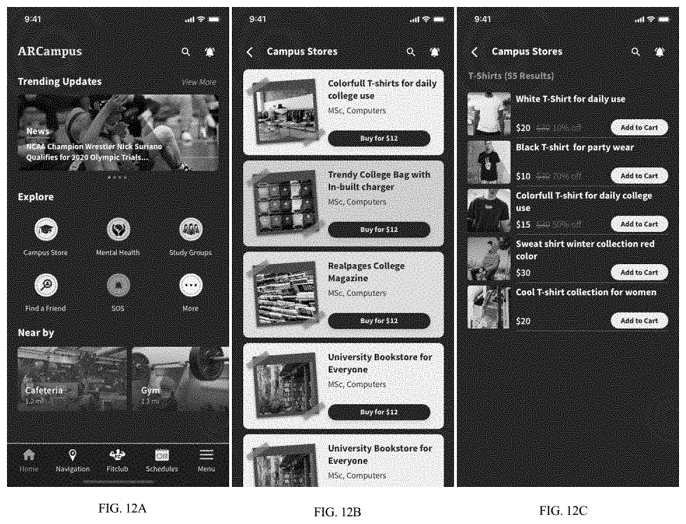

FIG. 11A illustrates a representative home screen, and FIGS. 11B through 11E illustrate representative study groups screens for a mobile application of the present disclosure used on a university campus. Referring to FIG. 11A, the “Home” icon is lit at the bottom of the screen, indicating that this is a home screen of the ARCampus mobile application. In an implementation, the home screen of FIG. 11A is substantially identical to the home screen of FIG. 9A. If a user selects the “Study Groups” icon from the “Explore” options on the home screen of FIG. 11A, the mobile application of the present disclosure may bring up study group screens, such as those shown in FIG. 11B through 11E, to enable the user to take various actions regarding study groups on campus. Referring to FIGS. 11B and 11C, the user may select either “Available Groups” or “Joined Groups” via a button at the top of the study group screen. FIG. 11B depicts a representative screen that may be presented if a user selects “Available Groups”. On this screen, a summary of each available study group is provided along with a “Join” button at the bottom of each summary. The summary may include a photograph of the study group leader, the name of the study group, the academic focus of the study group, a description of the study group, and the number of members of the study group.

FIG. 11C depicts a representative screen that may be presented if a user selects “Joined Groups”, assuming the user has selected the “Join” button for one or more study groups on the screen of FIG. 11B. On the “Joined Groups” screen of FIG. 11C, a summary of each joined study group is provided along with a “Set Reminder” button and a “Share Location” button at the bottom of each summary. The summary may include photographs of the study group members, the name of the study group, the academic focus of the study group, and a description of the study group. If a user clicks on the “Set Reminder” button, the user will be taken to a screen, such as the user's “Schedules” screens, to set a reminder about the study group. If a user clicks on the “Share Location” button, the system may enable the user to communicate a meeting location to the study group members.

Referring again to the “Available Groups” screen of FIG. 11B, instead of or in addition to joining an existing group, the user may create a new study group using the “Add New Group” button at the bottom of the screen. FIG. 11D shows a representative screen that may be displayed when a user selects the “Add New Group” feature. On the screen of FIG. 11D, a “Frequent” section may display the names and photographs of classmates the user frequently contacts, and a text box may also be provided to enable the user to search for other students. From this screen, the user may identify other students the user would like to add to, or invite to join, the new group. FIG. 11E shows a representative screen that may be displayed when a user identifies students on the screen of FIG. 11D. As shown in FIG. 11E, the number of participants and the associated photographs of the identified students may be displayed along with a “Create Group” button at the bottom of the screen. When a user presses the “Create Group” button, a new study group is formed that includes the identified students, or invitations are sent to the identified students to join the newly created study group.

FIG. 12A illustrates a representative home screen, and FIGS. 12B and 12C illustrate representative campus stores screens for a mobile application of the present disclosure used on a university campus. Referring to FIG. 12A, the “Home” icon is lit at the bottom of the screen, indicating that this is a home screen of the ARCampus mobile application. In an implementation, the home screen of FIG. 12A is substantially identical to the home screen of FIG. 9A.

If a user selects the “Campus Store” icon from the “Explore” options on the home screen of FIG. 12A, the mobile application of the present disclosure may bring up campus store screens, such as those shown in FIGS. 12B and 12C, to enable the user to purchase items from stores on campus. Referring to FIG. 12B, the user may be presented with a category list of items for sale at different campus stores. The category list of items may include a photograph, general description and price for each category. If a user selects one of the categories in the list, the user may be presented with a list of specific items within that category available for purchase. For example, if a user selects “Colorful T-shirts for daily college use” from the category list on the screen of FIG. 12B, the user may be presented with the list of specific shirts shown on the screen in FIG. 12C. The specific items in the list may include a photograph, description, color, size, price, discount, and other information. If a user would like to purchase one of the specific items in the list, the user may press the “Add to Cart” button next to the selected specific items. The user will then be directed to one or more screens to view the items added to their cart and otherwise complete the transaction, which may include purchasing the item through the mobile application, or may include reserving the item for purchase at the campus store.

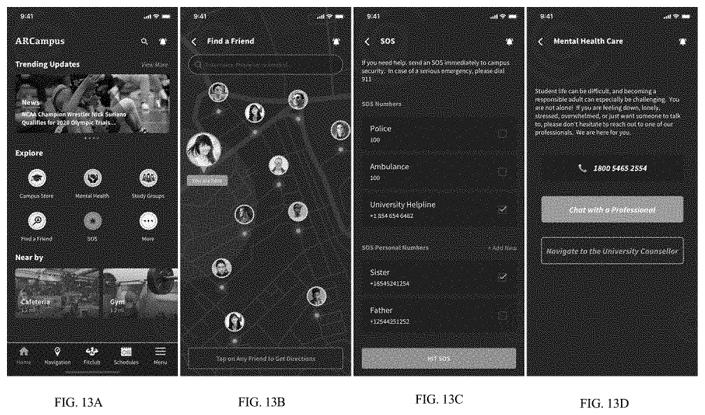

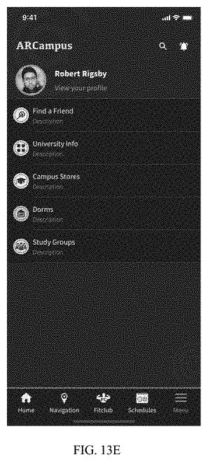

FIGS. 13A illustrates a representative home screen, and FIGS. 13B through 13E illustrate representative images of find a friend, SOS, mental health, and menu screens, respectively, for a mobile application of the present disclosure used on a university campus. Referring to FIG. 13A, the “Home” icon is lit at the bottom of the screen, indicating that this is a home screen of the ARCampus mobile application. In an implementation, the home screen of FIG. 13A is substantially identical to the home screen of FIG. 9A.

If a user selects the “Find a Friend” icon from the “Explore” options on the home screen of FIG. 13A, the mobile application of the present disclosure may bring up a screen as shown in FIG. 13B that enables a user to locate a friend and get directions to that friend's location. As shown in FIG. 13B, photographs of friends with location indicators may be displayed on a campus may and/or a text box may be provided to allow a user to type in the name of a friend they are attempting to find. When a user selects a photograph for a friend, the user may then select the “Tap on Any Friend to Get Directions” button at the bottom of the screen of FIG. 13B to get navigational directions to that friend's location.

If a user selects the “SOS” icon from the “Explore” options on the home screen of FIG. 13A, the mobile application of the present disclosure may bring up a screen as shown in FIG. 13C that enables a user to seek emergency assistance from first responders, family or friends. As shown in FIG. 13C, quick dial first responder contacts may be listed under “SOS Numbers” such as “Police”, “Ambulance” and “University Helpline”. Other first responders may include “Campus Security”. As shown in FIG. 13C, quick dial family and friend contacts may be listed under “SOS Personal Numbers”. The user may add more contacts to each category via an “Add New” button. The user may select one or more contacts by clicking boxes next to the contact names, and then press the “Hit SOS” button at the bottom of the screen to dial those selected contacts to receive emergency assistance.

If a user selects the “Mental Health” icon from the “Explore” options on the home screen of FIG. 13A, the mobile application of the present disclosure may bring up a screen as shown in FIG. 13D that enables a user to seek assistance from mental health professionals. As shown in FIG. 13D, the screen may provide a quick dial phone number, such as a suicide prevention hotline, for the user to make immediate contact for mental health assistance. The screen may also provide a “Chat with a Professional” button and a “Navigate to the University Counselor” button. If the user selects the “Chat with a Professional” button, the mobile application may bring the user to an appointment screen to set an appointment with a mental health professional, or the mobile application may bring up a screen that enables the user to interact in real-time with a mental health professional via text messaging, video conference, or other methods. If the user selects the “Navigate to the University Counselor” button at the bottom of the screen of FIG. 13D, the mobile application may provide navigational directions to the university counselor's office.

If a user selects the “Menu” button at the bottom of the home screen of FIG. 13A, the mobile application of the present disclosure may bring up a screen as shown in FIG. 13E that provides a menu of items pertaining to the user, such as the name and photograph of the user, as well as buttons for “View your profile”, “Find a Friend”, “University Info”, “Campus Stores”, “Dorms”, “Study Groups” and other information. The user may select any of the buttons on this menu to be redirected within the mobile application to interactive screens associated with the relevant services.

### Advertising and Marketing

In some implementations, the systems and methods of the present disclosure may enable advertising and marketing by facilities to users or by users to other users. For example, a gym or fitness facility may advertise a membership promotion or a job opening, a university may advertise an event or a job opening, users may advertise items or services for sale to other users, and/or users may market to other users to form a club. The systems and methods of the present disclosure may support other types of advertising and marketing.

It is to be understood the implementations of the present disclosure are not limited to the particular systems or methods described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular implementations of the systems and methods described in the specification. As one of ordinary skill in the art will readily appreciate from the disclosure, systems and methods presently existing or later to be developed that perform substantially the same function or achieve substantially the same result as the corresponding implementations described herein may be utilized according to the present disclosure. Accordingly, the appended claims are intended to include within their scope such systems or methods.

1. A method for displaying active information to a user in an environment using an augmented reality mobile device application installed on a processor of a server coupled with a memory in a database to provide secure access over a network, the method comprising:
providing the augmented reality mobile device application designed to install on a mobile device having augmented reality capability, a camera, and a GPS system, the augmented reality mobile device application having user-selectable button functions operable to receive real time input from the user;
determining a location of the mobile device within the environment based on input from the GPS system;
displaying a rendering of the environment on a screen of the mobile device that identifies a position of one of more items within the environment; and
presenting an augmented reality person within the rendering of the environment; and
using the augmented reality person to guide the user in the environment;
wherein the user-selectable button functions include a “SOS” button that the user can select to request immediate assistance from personnel in the environment.

2. The method of claim 1, wherein:
the rendering identifies the position of workout equipment within a gym; and
the augmented reality person guides the user through a workout using the workout equipment.

3. The method of claim 1, wherein:
the rendering identifies the position of buildings on a university campus; and
the augmented reality person navigates the user around the university campus to a desired location.

4. The method of claim 1, wherein:
the rendering identifies the position of desks within a classroom on the university campus; and
the augmented reality person navigates the user to a desired desk.

5. The method of claim 1, wherein:
the rendering identifies the position of available parking spaces within a parking facility on the university campus; and
the augmented reality person navigates the user to a desired parking space.

6. The method of claim 1, wherein:
the rendering identifies the position of seating within a sports venue on the university campus; and
the augmented reality person navigates the user to a desired seat.

7. A non-transitory computer readable storage medium containing computer readable instructions that control a processor of a server coupled with a memory of a database to perform a method for displaying active information to a user in an environment, the method comprising:
providing the augmented reality mobile device application designed to install on a mobile device having augmented reality capability, a camera, and a GPS system, the augmented reality mobile device application having user-selectable button functions operable to receive real time input from the user;
determining a location of the mobile device within the environment based on input from the GPS system;
displaying a rendering of the environment on a screen of the mobile device that identifies a position of one of more items within the environment; and
presenting an augmented reality person within the rendering of the environment; and
guiding the user in the environment using the augmented reality person;
wherein the user-selectable button functions include a “SOS” button that the user can select to request immediate assistance from personnel in the environment.

8. An augmented reality system comprising:
a mobile device installed with an augmented reality application for displaying active information to a user in an environment, the mobile device including augmented reality capability, a camera, and a GPS system;
a server connected a network, the server receiving requests from the user via the network, the server comprising:
a processor;
a database for storing information about the environment; and
a memory operatively coupled to the processor, the memory storing program instructions that, when executed by the processor, causes the processor to perform a function;
whereby the augmented reality application facilitates using an augmented reality person to guide the user in the environment.
